(19) United States
(12) Patent Application Publication
(10) Pub. No.: US 2020/0070494 A1
(43) Pub. Date: Mar. 5, 2020

(54) BEVERAGE CONTAINER PRINTING DEVICE

(71) Applicant: Twin Monkeys Beverage Systems, Inc., Aurora, CO (US)

(72) Inventors: Brian LeFevre, Brighton, CO (US); Josh Van Riper, Denver, CO (US)

(21) Appl. No.: 16/119,539

(22) Filed: Aug. 31, 2018

(51) Int. Cl. B41F 17/00

(52) U.S. Cl. CPC B41F 17/006

(57) ABSTRACT

A beverage container printing device including a frame, a container speed regulator mounted to said frame, a motor on said frame and drivingly engaged with said container speed regulator, an entry sensor disposed in an entry chute, an exit sensor disposed proximate an exit chute, and a control system for selectively operating said motor to drive said container speed regulator. The entry and exit sensors are each operable to determine the presence of a beverage container. In one embodiment, the container speed regulator may be in the form of a spiral device or star wheel. Beverage containers are fed by gravity to the printing device, the speed is controlled to ensure a quality print of text or symbols, and the speed regulator device in concert with a stop sensor stop the beverage containers at a position to ensure a quality print during a shutdown or startup condition of the machine.

### BACKGROUND OF THE INVENTION

The present state of the art is in the need of a beverage container printing device that creates a more replicable print and improves the quality of the printing so that operators don't lose beverage containers and have to pull them out because the printer didn't work upon start and stop.

In general, beverage containers are fed into a printer using gravity, which results in the beverage containers flowing downhill. Due to the nature of the feeding of these beverage containers, there may occasionally be a jam at the top of the supply, which results in an irregular speed of the feed and a bunch of beverage containers going faster by the printer than the printer is calibrated to receive. This results in a percentage of beverage containers that cannot be filled with product due to the non-conforming printed text or symbol.

Present beverage container printers do not implement control of the speed of the beverage container in the printing area and rely solely on a gravity feed. There are a number of irregularities that occur when coding or printing on the bottom of a beverage container which provide challenges when trying to ensure an even and high quality printing device during operation and upon the start-up and stop required during operation. In some cases, a beverage container could stick to the rails and not slide down, a gap between beverage containers could be present; a back-up could occur downstream, a couple of beverage containers could be in the entry chute, but have nothing in front of them or behind them, causing the beverage containers go faster or slower than usual. The printer may apply a code, such as a packaging date, or other symbol or message.

Further, there is currently a lot of unusable beverage containers and other wasted product resulting from mis-application of the code/message due to failures of existing beverage container printing devices to coordinate the stoppage and starting of the printing device. In these cases, there are no controls to stop the beverage container conveyance at a position that ensures the complete printing of one beverage container and stopping so the next beverage container receives a full and high quality printed text or symbol. If a beverage containers stops at the wrong spot, then almost all of the printed code gets into one spacing instead of across the beverage container.

In addition, the vibration of the whole beverage packaging machine affects the movement of the beverage containers and can affect the print quality.

In short, there is a need in the art of beverage packaging to create a controlled zone where beverage container is conveyed evenly, consistently and accurately in the printing zone to improve the print quality and reliability.

### SUMMARY OF THE INVENTION

The present invention is directed toward a beverage container printing device that generally may include a frame, a container speed regulator mounted to the frame, a motor mounted on the frame and drivingly engaged with the container speed regulator, an entry sensor disposed in an entry chute, wherein the entry sensor may be operable to determine the presence of a beverage container, an exit sensor disposed proximate an exit chute, wherein the exit sensor may be operable to determine the presence of a beverage container, and a control system for selectively operating the motor to drive the container speed regulator.

The beverage container printing device may also include a guide system for guiding a beverage container through the beverage container printing device. The guide system may include one or more set of guiding rails, including a top rail, a bottom rail, a far side rail and a near side rail. In one embodiment, at least one of the side rails and/or the top rail is adjustable so as to accommodate and guide beverage containers of varying size. The position of the members, therefore, can be adjusted match the dimensions of the beverage container.

The container speed regulator may comprise one of: a screw device, a star-wheel, or a pinch belt. In an embodiment where the container speed regulator comprises a screw device, the screw device may have a continuous spiral defined by a crest and a valley. The valley may include a curved surface that receives a portion of a cylindrical beverage container.

The invention may also include a beverage container printing system that similarly may include a container speed regulator, a motor drivingly engaged with the container speed regulator, an entry sensor disposed in an entry chute, wherein the entry sensor may be operable to determine the presence of a beverage container, an exit sensor disposed proximate an exit chute, wherein the exit sensor may be operable to determine the presence of a beverage container; and a control system for selectively operating the motor to drive the container speed regulator upon the entry sensor and the exit sensor detecting an operating condition.

In this embodiment, the operating condition may include a detected presence of a beverage container in the entry chute by the entry sensor and no detected presence of a beverage container in the exit chute by the exit sensor. Further, the control system may turn off the motor to stop the container speed regulator when one of (a) the entry sensor does not detect the presence of a beverage container in the entry chute, or (b) the exit sensor detects the presence of a beverage container in the exit chute, and a stop sensor detects the position of a target beverage container at a stop position after text or symbol has been printed on the target beverage container so that the printing device does not stop in the middle of printing a beverage container, improving the quality of the printing and avoiding waste.

In addition the invention may include a method for printing text or a symbol on a beverage container, the method comprising the steps of: conveying a beverage container through a printing device at a uniform speed using a container speed regulator disposed on the printing device to operably engage a feed of beverage container, and printing a text or a symbol on a target beverage container when the target beverage container is located at a printing position of the printing device. In one embodiment, the container speed regulator may be one of a screw device, a star-wheel, or a pinch belt system.

Other steps that may be included in the method of the present invention include at least sensing whether or not a beverage container is present in an entry chute upstream of the printing device using an entry sensor; sensing whether or not a beverage container is present in an exit chute downstream of the printing device using an exit sensor; operating the printing device when a beverage container is present at the entry chute and when a beverage container is not present in the exit chute; stopping the printing device when either a beverage container is not present at the entry chute or when a beverage container is present in the exit chute; and operating the printing device until the target beverage container is fully printed immediately prior to the step of stopping the printing device.

The method may also include the step of guiding the feed of beverage container using a guide system, and/or adjusting the position of one of a far side rail or a top rail of the guide system to match the dimensions of the beverage container.

Other aspects and advantages of the present invention will be apparent from the following detailed description of the preferred embodiments and the accompanying drawing figures.

### DESCRIPTION OF THE SEVERAL VIEWS OF THE DRAWING

In the following, an advantageous embodiment of the present invention will be explained in more detail making reference to a drawing, in which the individual figures show:

FIG. 1 is a top perspective view of one embodiment of a beverage container printing device in accordance the teachings of the present disclosure;

FIG. 2 is a bottom perspective view of one embodiment of a beverage container printing device in accordance the teachings of the present disclosure;

FIG. 3 is a side view of one embodiment of a beverage container printing device in looking upstream toward the exit and in accordance the teachings of the present disclosure; and

FIG. 4 is a top view of one embodiment of a beverage container printing device in accordance the teachings of the present disclosure; and

FIG. 5 is a side view of one embodiment of a beverage container printing device in accordance the teachings of the present disclosure.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

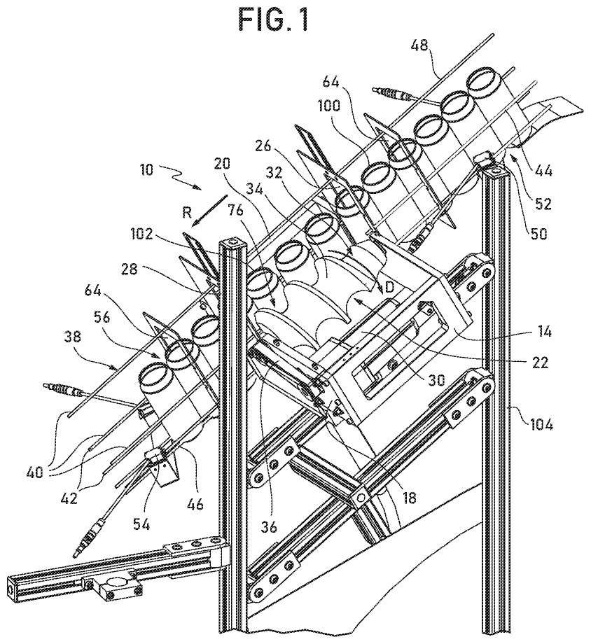

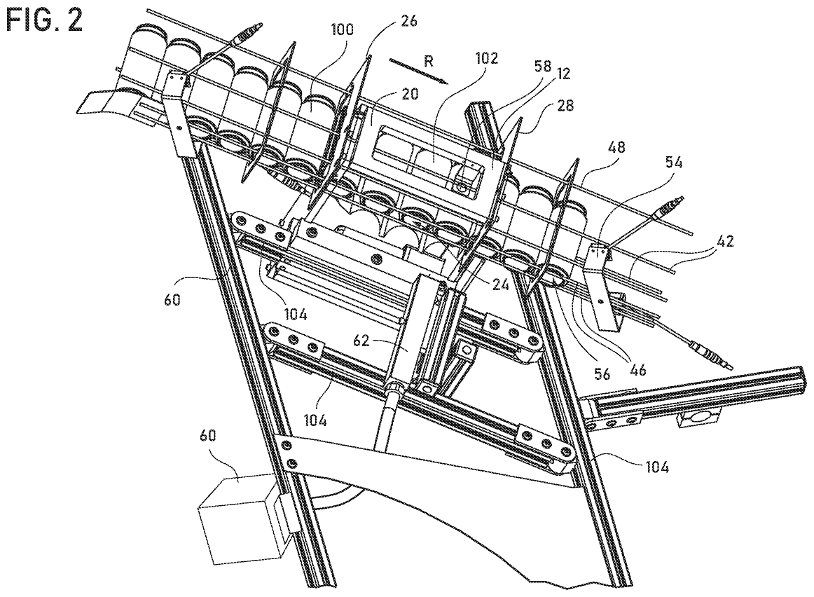

FIG. 1 illustrates one embodiment of the present beverage container printing device 10. As shown in FIG. 1, beverage container printing device 10 includes a frame 12, wherein frame 12 includes a first side 14, a second side 16, a third side 18 and a fourth side 20. As shown in FIG. 1, frame 12 may have a rectangular shape wherein first side 14 is opposite fourth side 20 and second side 16 is opposite third side 18. Other frame shapes are within the scope of the present invention. Frame 12 may include an open top 22 and an open bottom 24 (see FIG. 2). In addition second side 16 includes a first container passage cut out 26 and third side 18 includes a second container passage cut out 28 which are both sized to accommodate the largest beverage container 100 being utilized in the beverage packaging machine. Frame members may be made from solid plate material that may include elements or openings machined into the solid material, or be a space frame comprised of frame members connected together or trussed to form a stable frame.

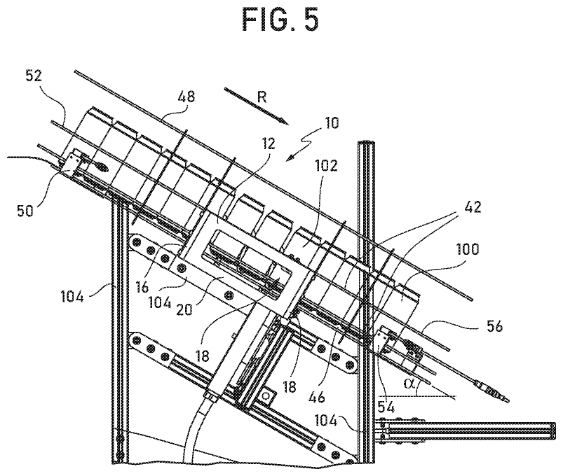

As further shown in FIG. 1, beverage container printing device 10 may include a drive or motor 30. In the embodiment shown, motor 30 is mounted on frame 12. Motor 30 is arranged to drive a container speed regulator 32. Container speed regulator 32 is shown in FIG. 1 as a time screw mechanism 34. Timing screw 34 feeds the beverage containers 100 through the beverage container printing device 10 in a conveyance direction R and positions a target beverage container 102 over the printing head 62 at the printing position 76 (see FIG. 5) at a known and controlled speed so as to achieve a clear printing. The present invention would include other container speed regulation devices known in the art or hereafter developed, including but not limited to a star wheel, a belt drive, including pinch belts, or other belt drive configuration for conveying the beverage container through the beverage container printing device 10 at a known speed.

In the embodiment shown, motor 30 is operably connected to drive container speed regulator 32 (screw 34) via a belt transmission 36. However, any transmission capable of conveying a drive force of a motor or drive 30 to the container speed regulator 32 is within the scope of the present invention. Motor 30 may be a fixed speed motor, a variable speed motor, a stepper motor, a servo motor, or an air motor. Motor 30 may be any drive known in the art that allows for the speed of the beverage container 100 to be controllable through the present printing device 10.

FIG. 1 also shows beverage container printing device 10 including a container feed guide system 38 comprised of a number of guide rails 40. As shown in FIG. 1, container feed guide system 38 may include far side rails 42 away from beverage container speed regulator 32 and near side rails 44 adjacent to beverage container speed regulator 32. Container feed guide system 38 may also include bottom rails 46 and top rails 48. FIG. 2 shows a different perspective of the container feed guide system 38 showing bottom rails 46, top rails 48 and far side rails 42. As can be seen in FIG. 2, one desirable feature is that bottom rails 46 are spaced apart so as to provide a clear path to the bottom of target beverage container 102 to effectuate the printed image. If the bottom guide element is a platform or solid shelf or rail, then such platform would require a cut-out that provides access to the bottom of target beverage container 102 for printing an image thereon.

Turning back to FIG. 1, container feed guide system 38 includes at least an entry sensor 50 that is disposed in a container feed chute 52, and an exit sensor 54 that is disposed in a container exit chute 56. The entry and exit sensors 50 and 54 may be any sensor that can detect the presence of a beverage container. Beverage containers 100 are fed into the present beverage container printing device 10 through the feed chute 52 and exit the beverage container printing device 10 through the exit chute 56. Generally, feed chute 52 is configured to align the beverage containers in a single file and stacked feed into beverage container printing device 10. Exit chute 56 may also align the beverage containers in a single file and stacked feed for further processing in a beverage packaging machine.

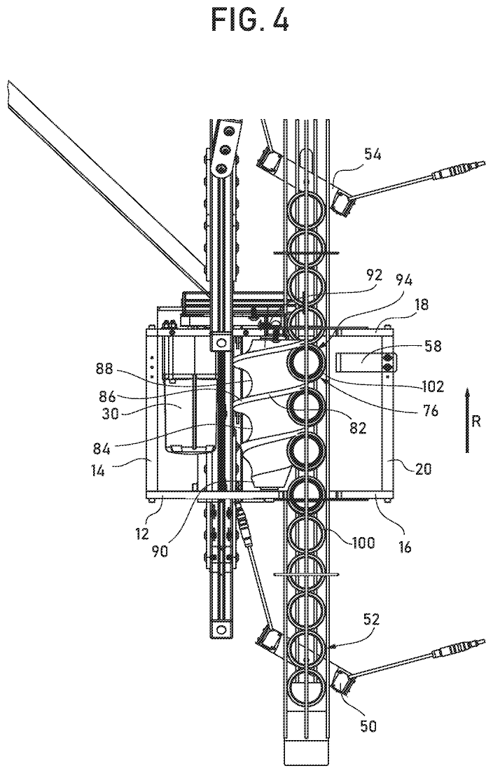

As shown in FIGS. 2 and 4, beverage container printing device 10 further includes a stop sensor 58 disposed on fourth side 20 of frame 12 for detecting the presence of target beverage container 102 at printing position 76. At printing position 76, beverage container printing device 10 includes a printer 60 mounted on machine frame 104 that is operably connected to a printer head 62 that is mounted to frame 12 or machine frame 104 and, in this embodiment, is disposed under target beverage container 102 at printing position 76. Any beverage container printer and printing head now known or hereafter developed may be included in the present invention. Provided, however, it is preferred to include a printer 60 and printer head 62 that are operable to print a moving target container 102 so as to print text or a symbol on the target container 102 while it is moving through beverage container printing device 10. The printer 60 is typically mounted to the machine frame 104 below the printing device 10, and is in communication with the printer head 62 using a long cord that delivers ink to the print head.

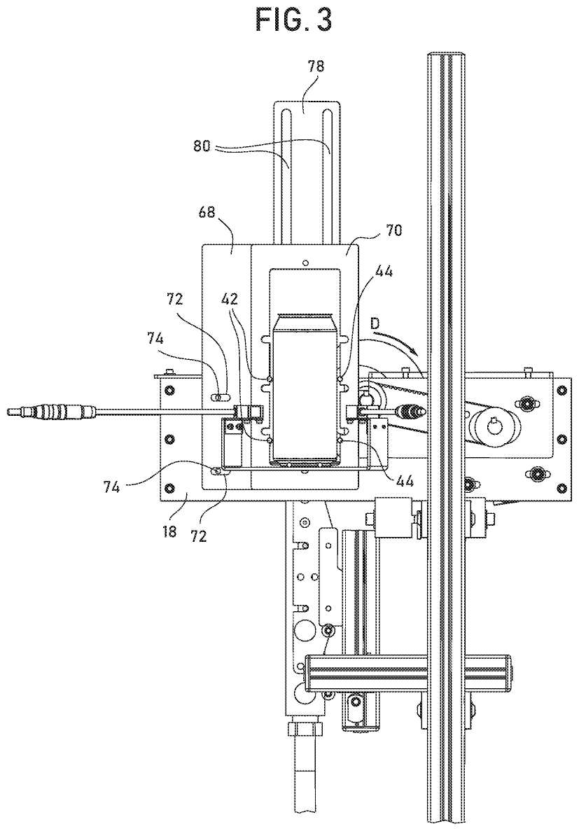

FIG. 3 shows one embodiment of beverage container printing device 10 that includes a beverage container guide opening 64 at both the entrance (see FIG. 1) and exit of the beverage container printing device 10. Further, FIG. 3 shows an adjustable guide system 66 that accommodates the use of a variety of beverage container diameters, widths, and/or heights. Alternatively, another embodiment may include a fixed guide system may be utilized as it provides a more simple design and operation when only one size and type of beverage container is used.

As shown in FIG. 3, adjustable guide system includes a first plate member 68 that is in at least partial overlap and sliding engagement with second plate member 70. In one embodiment, first and second plate members 68 and 70 define beverage container guide opening 64 either alone or in combination. In the embodiment shown, beverage container guide opening 64 is fixed in second plate member 70. As best shown in FIG. 3, the position of far side guide rails 42 may be moved in a direction that is transverse to conveying direction R of beverage containers 100 and toward and away from container speed regulator 32.

As show in FIG. 3, first plate 68 has two horizontally extended slots 72 that allow for a position of first plate 68 to be adjusted relative to both third side 16 and second plate 70. A fastener 74 may be connected to third side 18 of frame 12 and extend through slot 72 such that a securing element (not shown) may be activated so as to fix the position of first plate 68. The securing element may be a nut, wing-nut, cam closure, or any other clamping device to secure first plate 68 in position during operation. As shown in FIG. 3, far side rails 42 are connected to first plate 68 so that the position of far side rails 42 may be adjusted toward or away from container speed regulator 32 that the far side rails 42 are positioned to guide the beverage container 100 in engagement with container speed regulator 32 as the beverage container 100 is conveyed through the present printing device 10 (see FIG. 4). The same assembly can be implemented at second side 16 of frame 12 as shown in FIG. 1.

In addition, FIG. 3 illustrates an embodiment wherein top rail 48 is adjustable in a vertical direction so as to accommodate beverage containers having differing heights. Top rail 48 may be coupled to a height adjustment bracket 78 that includes two vertical slots 80 with a fastener or other clamping device known in the art to fix the position of height adjustment bracket 78 relative to second plate 70 as shown. However, height adjustment bracket 78 may include any number of vertical slots 80. The top rail 48 vertical height adjustment feature may include a fastener, such as a nut and a bolt, a cam closure, or other clamping mechanism which can be selectively engaged to fix the position of height adjustment bracket 78 to second plate 70. FIG. 3 show height adjustment bracket disposed at a fully raised position. The combination of the adjustable top guide 48 and the adjustable position far side guide 42 provide the flexibility to successfully print on the bottom of beverage containers of various sizes as these elements can be positioned to match the dimensions of the beverage containers used in the beverage packaging machine.

FIG. 4 shows how the near side rails 44 and far side rails 42 engage the beverage container 100 as it is guided through the present printing device 10. FIG. 4 more clearly shows entry sensor 50 disposed in a beverage container feed chute 52, and exit sensor 54 being disposed in a beverage container exit chute 56. FIG. 4 also shows stop sensor 58 disposed to detect that the target beverage container 102 is at the printing position 76. The sensors may be any sensor type known in the art. In one embodiment, entry and exit sensors 50 and 54 may be a through beam photo eye that is looking for the condition when the beverage containers block that eye for a certain amount of time.

FIG. 4 shows an embodiment of the speed regulation device container speed regulator 32 as a screw device 34. As can be seen, screw device 34 may include a crest 82 and a corresponding valley 84 that define a continuous spiral 86 so that a rotation in the advance direction D will advance the beverage containers 100 through the present printing device 10 in the conveyance direction R. In one embodiment shown in FIG. 4, valley 84 may be defined by a curved surface 88 where curved surface may be a uniform curve or a compound curve to best receive a circular beverage container of various diameters.

Further, screw device may include a tapered entry end 90 that has a smaller diameter that gradually increases in the production direction to gradually engage a container 100 entering screw device 34. Screw device 34 may also include an exit end 92 that includes an end to release the beverage container 100 out into the exit chute 56.

In use, the present printing device is configured to provide a more efficient beverage container printer that provides high quality printed text or symbols on beverage containers and significantly reduces the number of printing errors thereby increasing overall efficiency of the beverage packaging machine. Beverage containers 100 are fed into the present printing device via feed chute 52. Feed chute may be configured at a downward angle into the present printing device 10 to result in a gravity feed of beverage containers 100. As shown in FIG. 5, in one embodiment, the bottom rails 46 support the bottom of the beverage containers 100 and are orientated at an angle α relative to horizontal. In one embodiment, the angle is around twenty degrees (20°) to around thirty degrees (30°). In the embodiment shown in FIGS. 1-4, the beverage containers 100 slide down the bottom rails 46 into the printing device 10. At some times, beverage containers 100 may get stuck or slide in an irregular speed or intervals.

In one embodiment, the beverage containers are cylindrical aluminum or metal cans and the entry sensor 50 monitors whether there are beverage containers 100 upstream of the print head 62 and exit sensor 54 monitors whether there is a back log of beverage containers downstream of the print head 62. Optimal operating conditions include a number of beverage containers upstream of the print head 62 to provide additional gravity force on the beverage containers being printed, and no beverage containers downstream of the print head so the target beverage container 102 is printed while it is being conveyed past the printer. If there is a backup of beverage containers downstream, it may prevent the target beverage container from passing entirely pass the print head. Thus, the present printing device 10 uses upstream and downstream conditions to determine when the present printing device 10 and components thereof is operated and when it isn't.

In operation, entry sensor 50 determines whether a beverage container 100 is present upstream of printing device 10 and exit sensor 54 determines whether a beverage container 100 is present downstream of printing device 10. If either a beverage container 100 is not present upstream or a beverage container 100 is present downstream, then a control system (not shown) does not turn on printing device 10. However, if both (1) beverage container 100 is detected upstream and (2) there is not a beverage container detected downstream, then the control system turns on motor 30 to drive the beverage container speed regulator 32 (the screw drive 34). As seen best in FIG. 4, beverage container 100 travels through entry chute 52 and passes by the tapered end 90 of the screw drive 34 until it engages crest 82. As the screw turns in direction D at a constant speed, beverage container 100 is urged through the printer 10 as a portion of the beverage container 100 is received into valley 84. As further shown far side rails 42 guide the beverage container and are positioned such that the beverage container maintains contact with screw 34. When beverage container 100 becomes a target beverage container 102 positioned at the printing position 76, the printer activates print head 62 to print text or a symbol on the bottom of target beverage container 102. The printer can be calibrated to the speed of the beverage container speed regulator 32 so that the printed image is clear and legible and the text/image is applied to match the speed the beverage containers 100 are moving. In one embodiment, the printed text is the packaging date; however, other text or symbols could be incorporated include a QR code containing product data, a marketing message, or other text or symbol as desired.

The screw device 34 and beverage container printer 10 will continue to operate until the sensors 50 and 54 detect an anomaly in the operation or the operator needs to shut down the machine for any number of reasons. In the event that either entry sensor 50 does not detect a beverage container 100 or exit sensor 54 detects the presence of a beverage container 100 then the present beverage container printing device 10 can stop operation. The control system keeps conveying the next beverage container 100 until it reaches a stop position 94 as detected by stop sensor 94. In one embodiment, the stop position 94 is a position from which the target beverage container 102 stopped immediately after the printer has printed the entire text or symbol on the bottom of the beverage container 100 in the printing position 76 (see FIG. 4). This position ensures that when the printing device 10 stops, the beverage container being printed 102 receives a full and high quality printed text or symbol, and also ensures that when the printing device 10 starts up again, the next upstream beverage container is fed into the printer head to receive a full and high quality printed text or symbol. This control feature and arrangement of sensors is novel and provides increased efficiency and less waste in the beverage container packaging industry.

When entry sensor 50 detects that there are beverage containers 100 upstream of the beverage container printing device 10 and the exit sensor does not sense any beverage containers, then the control system of beverage container printing device 10 resumes operations such that a new beverage container 100 enters printing position 76 as the target beverage container 102 (already printed prior to stopping the machine) is conveyed out of the printing device. In this embodiment, the stop position corresponds to the printing position, but it could be any position relative to the printer head that results in a legible and good quality print upon restarting the present printing device. This sequence is important because it creates a more replicable print and improves the quality so that you don't lose beverage containers and have to pull them out because the printer didn't work upon start and stop of the printing device 10.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A beverage container printing device comprising:
a frame;
a container speed regulator mounted to said frame;
a motor mounted on said frame and drivingly engaged with said container speed regulator;
an entry sensor disposed in an entry chute, said entry sensor operable to determine the presence of a beverage container;
an exit sensor disposed proximate an exit chute, said exit sensor operable to determine the presence of a beverage container; and
a control system for selectively operating said motor to drive said container speed regulator.

2. The beverage container printing device of claim 1 further comprising a guide system for guiding a beverage container through the beverage container printing device.

3. The beverage container printing device of claim 1 wherein the container speed regulator comprises a screw device having a continuous spiral defined by a crest and a valley, wherein the valley includes a curved surface that receives a portion of a cylindrical beverage container.

4. The beverage container printing device of claim 1 wherein the container speed regulator comprises one of: a screw device, a star-wheel, or a pinch belt.

5. The beverage container printing device of claim 1 wherein a guide system for guiding a beverage container through the beverage container printing device.

6. A beverage container printing system comprising:
a container speed regulator;
a motor drivingly engaged with the container speed regulator;
an entry sensor disposed in an entry chute, said entry sensor operable to determine the presence of a beverage container;
an exit sensor disposed proximate an exit chute, said exit sensor operable to determine the presence of a beverage container; and
a control system for selectively operating said motor to drive said container speed regulator upon the entry sensor and the exit sensor detecting an operating condition.

7. The beverage container printing system of claim 5 wherein said operating condition comprises a detected presence of a beverage container in the entry chute by the entry sensor and no detected presence of a beverage container in the exit chute by the exit sensor.

8. The beverage container printing system of claim 5 wherein said control system turns off the motor to stop said container speed regulator when one of (a) the entry sensor does not detect the presence of a beverage container in the entry chute, or (b) the exit sensor detects the presence of a beverage container in the exit chute; and
a stop sensor detects the position of a target beverage container at a stop position after text or symbol has been printed on the target beverage container.

9. A method for printing text or a symbol on a beverage container, the method comprising:
conveying a beverage container through a printing device at a uniform speed using a container speed regulator disposed on said printing device to operably engage a feed of beverage container; and
printing a text or a symbol on a target beverage container when said target beverage container is conveyed across a printing position of said printing device.

10. The method of claim 9 further comprising:
sensing whether or not a beverage container is present in an entry chute upstream of said printing device using an entry sensor;
sensing whether or not a beverage container is present in an exit chute downstream of said printing device using an exit sensor;
operating the printing device when a beverage container is present at said entry chute and when a beverage container is not present in the exit chute;
stopping the printing device when either a beverage container is not present at said entry chute or when a beverage container is present in the exit chute; and
operating the printing device until said target beverage container is fully printed immediately prior to said step of stopping the printing device.

11. The method of claim 9 further comprising the step of guiding the feed of beverage container using a guide system.

12. The method of claim 10 further comprising the step of adjusting the position of one of a far side rail or a top rail of said a guide system to match the dimensions of the beverage container.

13. The method of claim 9 wherein the container speed regulator is one of a screw device, a star-wheel, or a pinch belt system.
